(19) United States
(12) Patent Application Publication
(10) Pub. No.: US 2022/0308905 A1
(43) Pub. Date: Sep. 29, 2022

(54) AUTOMATIC SELECTION OF LANGUAGE FOR GRAPHICAL USER INTERFACE OF ELECTRONIC DEVICE BASED ON WIFI COUNTRY CODE

(71) Applicant: ARRIS Enterprises LLC, Suwanee, GA (US)

(72) Inventor: Jinghui WU, Shenzhen, Guangdong (CN)

(21) Appl. No.: 17/292,530

(22) PCT Filed: Jun. 17, 2020
(86) PCT No.: PCT/CN2020/096598

§ 371 Date: May 10, 2021

(51) Int. Cl. G06F 9/451; H04W 4/02; G06F 3/0481

(52) U.S. Cl. CPC G06F 9/454; H04W 4/025; G06F 3/0481

(57) ABSTRACT

An electronic device includes a memory having stored therein: software, a configuration file, and a table associating reference Wi-Fi country codes with graphical user interface (GUI) languages; and a processor configured to run the software to cause the electronic device to execute at least the following: read a current Wi-Fi country code of the electronic device from the configuration file; obtain, from the table, the GUI language which is associated with the reference Wi-Fi country code corresponding to the current Wi-Fi country code of the electronic device; and modify the configuration file stored in the memory so as to automatically select a language setting for a GUI of the electronic device based on the GUI language obtained from the table.

### TECHNICAL FIELD

The subject matter of the present disclosure relates generally to automatic selection of a language for a graphical user interface (GUI) of an electronic device.

### BACKGROUND

Wireless networks for providing services to client devices or end devices via a modem or gateway device are prevalent in many homes and businesses. Additionally, there can be several modems or gateway devices deployed in the home or business to enhance quality of service (QoS) in the network.

The modem/gateway device may feature a GUI displaying graphical elements such as icons, cursors, and windows to a user so as to facilitate interaction of the user with the modem/gateway device. A GUI may be accessible via a web browser and may support multiple languages (such as English or German).

Typically, a default language for the GUI may be preprogrammed into the modem/gateway device based on the customer index in firmware of the modem/gateway device. For example, a modem/gateway device to be deployed in Europe may have English (EN) preselected as the default language for the GUI of the modem/gateway device. However, if the customer conducts business in different countries using different languages, then a non-preferred or possibly even unintelligible language may be selected.

Further existing solutions require the user to manually reconfigure the GUI so as to feature another language that is preferred over the default language. The user must therefore find the login GUI, find the appropriate controller, and then manually change the language setting. However, this is burdensome due to the number of steps required and also because the user may not be able to understand how to reconfigure the GUI if the user is not fluent in the default language.

Thus, it would be advantageous and an improvement over existing solutions to provide an electronic device, a method, and a program for automatically selecting a language setting for a GUI of the electronic device.

### SUMMARY

An embodiment of the present disclosure provides an electronic device with automatic selection of a language for a GUI of the electronic device. The electronic device comprises a memory having stored therein: software, a configuration file, and a table associating reference Wi-Fi country codes with graphical user interface (GUI) languages; and a processor configured to run the software to cause the electronic device to execute at least the following: read a current Wi-Fi country code of the electronic device from the configuration file; obtain, from the table, the GUI language which is associated with the reference Wi-Fi country code corresponding to the current Wi-Fi country code of the electronic device; and modify the configuration file stored in the memory so as to automatically select a language setting for a GUI of the electronic device based on the GUI language obtained from the table.

An embodiment of the present disclosure provides a method for automatic selection of a language for a GUI of an electronic device. The method comprises reading a current Wi-Fi country code of the electronic device from a configuration file stored in a memory of the electronic device; obtaining, from a table stored in the memory associating reference Wi-Fi country codes with graphical user interface (GUI) languages, the GUI language which is associated with the reference Wi-Fi country code corresponding to the current Wi-Fi country code of the electronic device; and modifying the configuration file stored in the memory so as to automatically select a language setting for a GUI of the electronic device based on the GUI language obtained from the table.

An embodiment described in the present disclosure provides a non-transitory computer-readable recording medium in an electronic device for automatic selection of a language for a GUI of the electronic device. The non-transitory computer-readable recording medium stores one or more programs which when executed by a hardware processor performs the steps of the methods described above.

### BRIEF DESCRIPTION OF THE DRAWINGS

In the drawings, like reference numbers generally indicate identical, functionally similar, and/or structurally similar elements.

FIG. 1 is a schematic diagram of a system for automatic selection of a language for a GUI of an electronic device (e.g., a modem/gateway device or an access point) according to an embodiment of the present disclosure;

FIG. 2 is a more detailed schematic diagram of a modem/gateway device, and a client device in the system for automatic selection of a language for a GUI of an electronic device according to an embodiment of the present disclosure; and

FIG. 3 illustrates a method and algorithm for automatic selection of a language for a GUI of an electronic device according to an embodiment of the present disclosure.

### DETAILED DESCRIPTION

The following detailed description is made with reference to the accompanying drawings and is provided to assist in a comprehensive understanding of various example embodiments of the present disclosure. The following description includes various details to assist in that understanding, but these are to be regarded as merely examples. Accordingly, those of ordinary skill in the art will recognize that various changes and modifications of the examples described herein can be made without departing from the spirit and scope of the present disclosure. In addition, descriptions of well-known functions and constructions may be omitted for clarity and conciseness.

The terms and words used in the following description and claims are merely used to enable a clear and consistent understanding of the present disclosure. Accordingly, it should be apparent to those skilled in the art that the following description of the present disclosure is provided for illustration purposes only, and not for the purpose of limiting the present disclosure as defined by the appended claims and their equivalents.

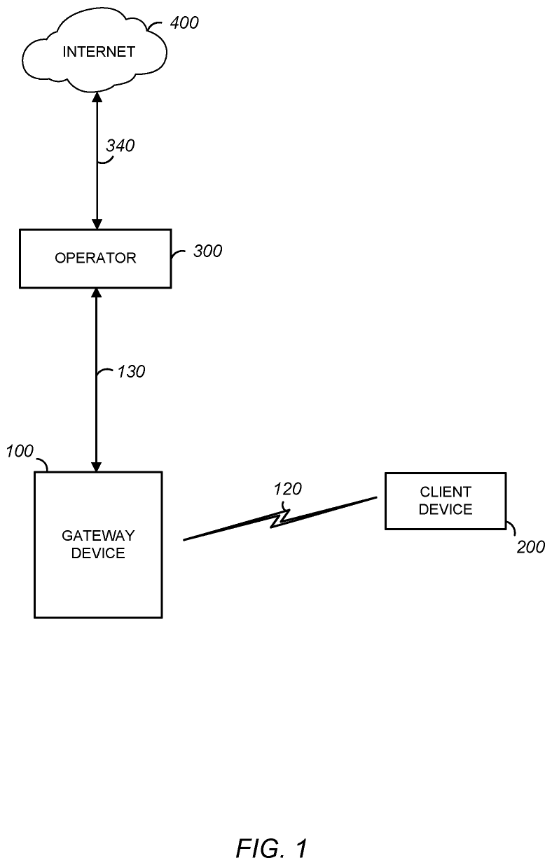

FIG. 1 is a schematic diagram of a system for automatic selection of a language for a GUI of an electronic device (e.g., a modem/gateway device or an access point) according to an embodiment of the present disclosure. As shown in FIG. 1, the system includes a modem/gateway device 100 connected to an operator 300 via a WAN connection 130 and also connected to a client device 200 via a connection 120 (e.g., a Wi-Fi connection). The WAN connection 130 constructively provides access to the Internet 400.

Although FIG. 1 shows one modem/gateway device 100 and one client device 200, any number of modem/gateway devices and any number of client devices may be included.

In FIG. 1, the operator 300 may include network equipment, (e.g., cable modem termination system, headend hardware, etc.), of a cable television provider, a satellite television provider, an Internet service provider (ISP), telco or multiple systems operator (MSO). The connection 340, the Internet 400, and the connection 130, between the operator 300 and the modem/gateway device 100 can be considered as encompassing and including any of a WAN, a virtual private network (VPN), metropolitan area networks (MANs), system area networks (SANs), a Data Over Cable Service Interface Specification (DOCSIS) network, a media over coax (MoCA) network, a fiber optics network (such as FTTH (fiber to the home) or FTTX (fiber to the x)), a hybrid fiber coaxial (HFC) network, a public switched data network (PSDN), a global Telex network, a digital subscriber line (DSL), or a wireless broadband system such as a 2G, 3G, 4G or 5G network, for example.

The modem/gateway device 100 is a hardware electronic device that acts as a router for providing content received from the operator 300 to network devices (e.g., client device 200) in one of more wireless networks. It is also contemplated by the present disclosure that the modem/gateway device 100 can be, but is not limited to, an Internet Protocol/Quadrature Amplitude Modulator (IP/QAM) set-top box (STB) or smart media device (SMD) that is capable of decoding audio/video content, and playing over-the-top (OTT) or MSO provided content.

In some variations, the device 100 may be an access point, such as a wireless extender. The wireless extender may be connected downstream of a gateway or another extender. The wireless networks may be connected by a backhaul link.

The client device 200 is, for example, any computer, smartphone, electronic tablet, e-reader, personal digital assistant (PDA), portable music player with smart capabilities, appliance, smart speaker, Internet of Things (IoT) device, iControl device, or other wireless consumer electronic device capable of executing and displaying the content received through, for example, the modem/gateway device 100. The client device 200 is capable of interconnecting with other devices via Wi-Fi protocols. The connection 120 between the modem/gateway device 100 and the client device 200 is implemented through a wireless connection that operates in accordance with, but is not limited to, any IEEE 802.11 protocol, RF4CE protocol, ZigBee protocol, Z-Wave protocol, or IEEE 802.15.4 protocol. In some embodiments, the client device 200 may also be capable of connecting to the Internet 400 over cellular networks and interconnecting with other devices via Bluetooth protocols.

In FIG. 1, as an exemplary implementation, the modem/gateway device 100 establishes a WLAN for communication using, e.g., Wi-Fi, and allows the client device 200 to access the Internet 400 via the WLAN established by the modem/gateway device 100.

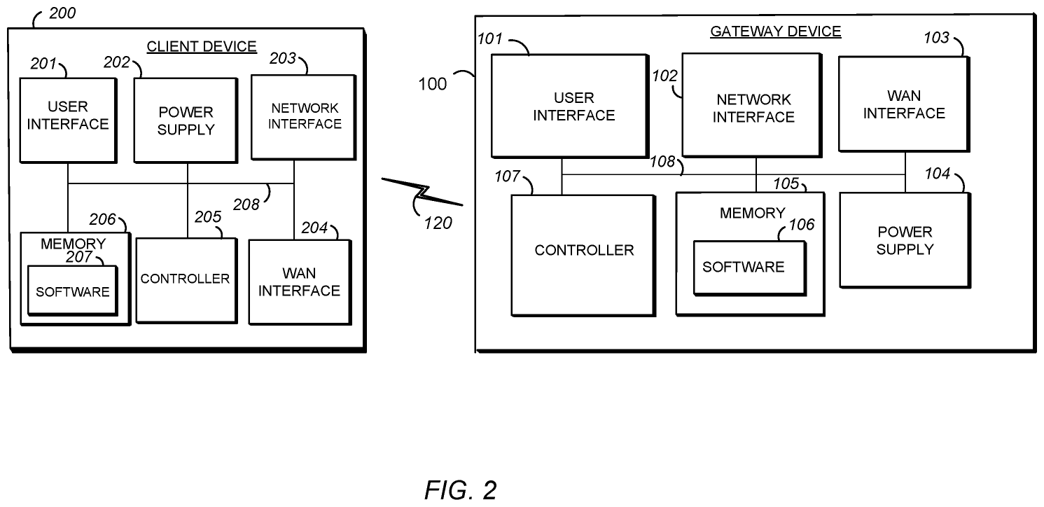

A detailed description of the exemplary internal components of the modem/gateway device 100 and the client device 200 shown in FIG. 1 will be provided in the discussion of FIG. 2. However, in general, it is contemplated by the present disclosure that the modem/gateway device 100 and the client device 200 include electronic components or electronic computing devices operable to receive, transmit, process, store, and/or manage data and information associated with the system, which encompasses any suitable processing device adapted to perform computing tasks consistent with the execution of computer-readable instructions stored in a memory or a computer-readable recording medium.

Further, any, all, or some of the computing devices in the modem/gateway device 100 and the client device 200 may be adapted to execute any operating system, including Linux, UNIX, Windows, MacOS, DOS, and Chrome OS as well as virtual machines adapted to virtualize execution of a particular operating system, including customized and proprietary operating systems. The modem/gateway device 100 and the client device 200 are further equipped with components to facilitate communication with other computing devices over the one or more network connections to local and wide area networks, wireless and wired networks, public and private networks, and any other communication network enabling communication in the system.

FIG. 2 illustrates a more detailed schematic diagram of the modem/gateway device 100 and the client device 200 in the system for automatic selection of a language for a GUI of an electronic device according to an embodiment of the present disclosure.

Now referring to FIG. 2 (e.g., from left to right), the client device 200 is any computer, smartphone, electronic tablet, e-reader, PDA, portable music player with smart capabilities, appliance, smart speaker, IoT device, iControl device, or other wireless consumer electronic device capable of executing and displaying the content received through, for example, the modem/gateway device 100. The client device 200 is capable of interconnecting with other devices via Wi-Fi protocols. As shown in FIG. 2, an exemplary client device 200 can include a user interface 201, a power supply 202, a network interface 203, a WAN interface 204, a controller 205, and a memory 206. The user interface 201 may include, but is not limited to, push buttons, a keyboard, a keypad, a liquid crystal display (LCD), a cathode ray tube (CRT), a thin film transistor (TFT), a light-emitting diode (LED), and/or a high definition (HD) or other similar display device including a display device having touch screen capabilities so as to allow interaction between a user and the client device 200. The power supply 202 supplies power to the internal components of the client device 200 through an internal bus 208. The power supply 202 includes a self-contained power source such as a battery pack with an interface to be powered through an electrical charger connected to an outlet (e.g., either directly or by way of another device). The power supply 202 can also include a rechargeable battery that can be detached allowing for replacement such as a nickel-cadmium (NiCd), a nickel metal hydride (NiMH), a lithium-ion (Li-ion), or a lithium Polymer (Li-pol) battery.

The network interface 203 can include various network cards, interfaces, and circuitry implemented in software and/or hardware to enable communications with the modem/gateway device 100 using connection 120 using a wireless protocol. The various network cards, interfaces, and circuitry enable communications via connection 120 using a wireless connection that operates in accordance with, but is not limited to, any IEEE 802.11 protocol, RF4CE protocol, ZigBee protocol, Z-Wave protocol, or IEEE 802.15.4 protocol.

In some embodiments, the client device 200 may be configured with a WAN interface 204 including Internet connection circuitry (via, e.g., a cellular network interface such as 2G, 3G, 4G, or 5G), allowing the client device 200 to access the Internet 400 via a WLAN established by the network interface 203 of client device 200 and via the WAN interface 204 of the client device 200. However, it is contemplated by the present disclosure that the WAN interface 204 could be omitted.

The memory 206 includes a single memory or one or more memories or memory locations that include, but are not limited to, random access memory (RAM), dynamic random access memory (DRAM), a memory buffer, a hard drive, a database, an erasable programmable read only memory (EPROM), an electrically erasable programmable read only memory (EEPROM), read only memory (ROM), flash memory, logic blocks of a field programmable gate array (FPGA), a hard disk or any other various layers of memory hierarchy.

The memory 206 can be used to store any type of instructions including software 207 associated with algorithms, processes, or operations for controlling the general functions and operations of the client device 200.

The controller 205 controls the general operations of the client device 200 and includes, but is not limited to, a central processing unit (CPU), a hardware processor such as, a microprocessor, a multi-core processor, a single core processor, a field programmable gate array (FPGA), a microcontroller, an application specific integrated circuit (ASIC), a digital signal processor (DSP), or other similar processing device capable of executing any type of instructions, algorithms, or software for controlling the operation and performing the functions of the client device 200. General communication between the components (e.g., 201-206) of the client device 200 may be performed using an internal bus 208.

The modem/gateway device 100 is a hardware electronic device that acts as a router for providing content received from a WAN interface 103 to the devices (e.g., client device 200) in a wireless network using connection 120. As shown in FIG. 2, the modem/gateway device 100 includes a user interface 101, a network interface 102, the WAN interface 103, a power supply 104, a memory 105, and a controller 107.

The network interface 102 may include various network cards, and circuitry implemented in software and/or hardware to enable communications with the client device 200 using connection 120. The various network cards, interfaces, and circuitry of the network interface 102 enable communications via connection 120 to the client device 200 using a wireless protocol that operates in accordance with, but is not limited to, any IEEE 802.11 protocol, RF4CE protocol, ZigBee protocol, Z-Wave protocol, or IEEE 802.15.4 protocol.

The WAN interface 103 may include various network cards, and circuitry implemented in software and/or hardware to enable communications with operator network 130 (not shown). The various network cards, interfaces, and circuitry of the network interface 102 enable communications to be routed from network interface 203 to the Internet 400 via the WAN interface 103.

The memory 105 includes a single memory or one or more memories or memory locations that include, but are not limited to, RAM, DRAM, a memory buffer, a hard drive, a database, an EPROM, an EEPROM, ROM, flash memory, logic blocks of a FPGA, a hard disk or any other various layers of memory hierarchy. The memory 105 can be used to store any type of instructions including software 106 associated with algorithms, processes, or operations for controlling the general functions and operations of the modem/gateway device 100 for automatic selection of a language for a GUI of the modem/gateway device 100.

The controller 107 controls the general operations of the modem/gateway device 100 and includes, but is not limited to, a CPU, a hardware processor such as a microprocessor, a multi-core processor, a single core processor, a FPGA, a microcontroller, an ASIC, a DSP, or other similar processing device capable of executing any type of instructions, algorithms, or software for controlling the operation and performing the functions of the modem/gateway device 100. Communication between the components (e.g., 101-105 and 107) of the modem/gateway device 100 may be established using an internal bus 108.

Default operational parameters in the form of one or more configuration files may be programmed into the memory 105. The default operational parameters may include a current language setting for the GUI of the modem/gateway device 100 and a current Wi-Fi country code as part of firmware of the modem/gateway device 100. The current Wi-Fi country code is a string which identifies the country in which the modem/gateway device 100 is to operate (e.g., .cc=“US”). In general, only Wi-Fi enabled devices have Wi-Fi country codes. A manufacturer may reprogram the current Wi-Fi country code per a request from an ISP as a part of region customization for each country a modem/gateway device is deployed to. In some implementations, the ISP may reconfigure the current Wi-Fi country code after manufacturing as desired. A table of reference Wi-Fi country codes associated with GUI languages which may be stored in the memory 105. Each reference Wi-Fi country code may be associated with one or more of the GUI languages. Furthermore, each reference Wi-Fi country code may be associated with one or more countries. Some GUI languages may be unsupported (i.e., the device 100 may be incapable of displaying the GUI in the GUI language associated with the reference Wi-Fi country code). The controller 107 can read the current Wi-Fi country code from the configuration file, refer to the table to obtain the GUI language which is associated with the reference Wi-Fi country code corresponding to the current Wi-Fi country code and automatically select a language setting for a GUI of the electronic device based on the GUI language obtained from the table.

The GUI of the modem/gateway device 100 may present a series of menus, tasks, or windows so as to enable the user to change settings or operational parameters of the modem/gateway device 100. The settings or operational parameters may relate to language, broadband, WAN, LAN, routing, remote management, blocking, filtering, security, etc. For example, a user may access the GUI of the modem/gateway device 100 by opening a web browser on the client device 200 and entering a Uniform Resource Locator (URL) or an Internet Protocol (IP) address assigned to the modem/gateway device 100.

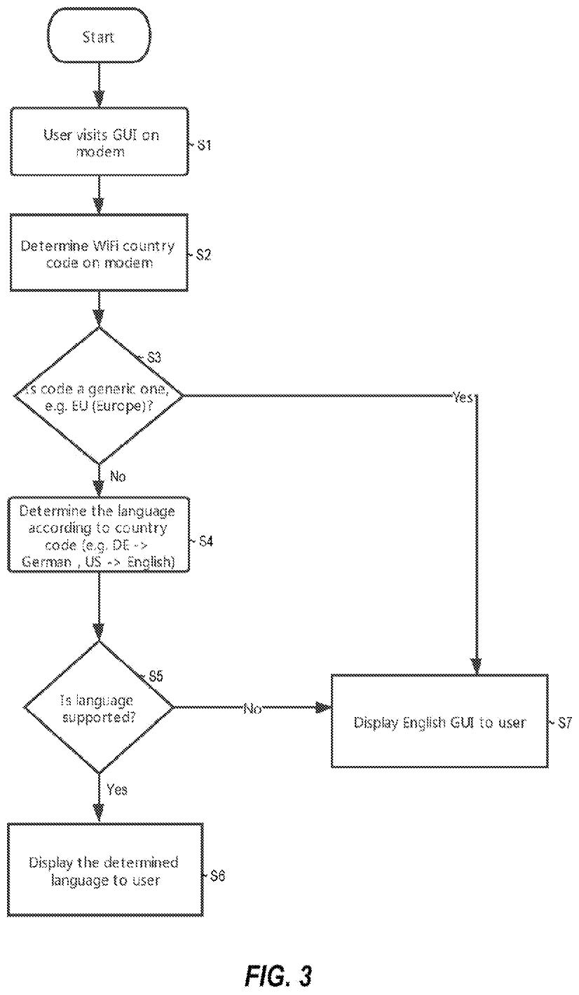

FIG. 3 illustrates an exemplary method and algorithm for automatic selection of a language for a GUI of the modem/gateway device 100 according to an embodiment of the present disclosure. It is assumed that the modem/gateway device 100 and the client device 200 include their respective software 106, 207 in their respective memories 105, 206. In FIG. 3, the method and algorithm illustrate operations performed by processors running the software 106 of the modem/gateway device 100 and the software 207 of the client device 200 for automatic selection of a language for a GUI of the modem/gateway device 100. The software 106, 207 in the respective memories 105, 206 can be for implementing, for example, a procedure between the modem/gateway device 100 and the client device 200 for automatic selection of a language for a GUI of the modem/gateway device 100.

In Step S1, the GUI of the modem/gateway device 100 is accessed by a user.

In Step S2, the current Wi-Fi country code of the modem/gateway device 100 is determined. For example, a batch script may be run to read the current Wi-Fi country code out of a configuration file in the registry of the modem/gateway device 100.

In Step S3, it is determined if the current Wi-Fi country code is specific (i.e., corresponds to only one country (e.g., “US”)) or generic (i.e., corresponds to more than one country (e.g., “EU”)). For example, a batch script may be run to compare the current Wi-Fi country code to the table of reference Wi-Fi country codes to determine how many countries correspond to the current Wi-Fi country code. If the current Wi-Fi country code is specific, the process proceeds to Step S4. If the current Wi-Fi country code is generic, the process proceeds to Step S7.

In Step S4, the GUI language associated with the reference Wi-Fi country code corresponding to the current Wi-Fi country code is determined. In other words, the GUI language associated with the reference Wi-Fi country code corresponding to the current Wi-Fi country code is obtained from the table. For example, German corresponds to “DE” and English corresponds to “US”, “CA”, “AU” or “GB”, etc.

In Step S5, it is determined if the GUI language obtained from the table is supported by the GUI of the modem/gateway device 100. In other words, it is determined if the modem/gateway device 100 is capable of displaying the GUI of the modem/gateway device 100 in the GUI language obtained from the table. For example, the table may include a field indicating whether each GUI language is supported. If the GUI language obtained from the table is supported, the process proceeds to Step S6. If the GUI language obtained from the table is unsupported, the process proceeds to Step S7.

In Step S6, a configuration file stored in the memory 105 is modified so as to automatically select a language setting for a GUI of the modem/gateway device 100 that matches the GUI language obtained from the table and the GUI of the modem/gateway device 100 is displayed in the GUI language obtained from the table.

In Step S7, a configuration file stored in the memory 105 is modified so as to automatically select English as the language setting for the GUI of the modem/gateway device 100 and the GUI of the modem/gateway device 100 is displayed in English. For example, if the current Wi-Fi country code is generic (e.g., “EU”), English may be automatically selected as the language setting for the GUI of the modem/gateway device 100. As another example, if the current Wi-Fi country code is “FR” and French is unsupported, English may be automatically selected as the language setting for the GUI of the modem/gateway device 100. Alternatively, if the GUI language (which is associated with the reference Wi-Fi country code corresponding to the current Wi-Fi country code) is unsupported, a closest supported GUI language may be automatically selected as the language setting for the GUI of the modem/gateway device 100.

The present disclosure may be implemented as any combination of an apparatus, a system, an integrated circuit, and a computer program on a non-transitory computer readable recording medium. The one or more processors may be implemented as an integrated circuit (IC), an application specific integrated circuit (ASIC), or large scale integrated circuit (LSI), system LSI, super LSI, or ultra LSI components that perform a part or all of the functions described in the present disclosure.

The present disclosure includes the use of software, applications, computer programs, or algorithms. The software, applications, computer programs, or algorithms can be stored on a non-transitory computer-readable medium for causing a computer, such as the one or more processors, to execute the steps described in FIG. 3. For example, the one or more memories store software or algorithms with executable instructions and the one or more processors can execute a set of instructions of the software or algorithms in association with automatic selection of a language for a GUI of a modem/gateway device.

The software and computer programs, which can also be referred to as programs, software applications, applications, components, or code, include machine instructions for a programmable processor, and can be implemented in a high-level procedural language, an object-oriented programming language, a functional programming language, a logical programming language, or an assembly language or machine language. The term computer-readable recording medium refers to any computer program product, apparatus or device, such as a magnetic disk, optical disk, solid-state storage device, memory, and programmable logic devices (PLDs), used to provide machine instructions or data to a programmable data processor, including a computer-readable recording medium that receives machine instructions as a computer-readable signal.

By way of example, a computer-readable medium can comprise DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Disk or disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

Use of the phrases “capable of,” “capable to,” “operable to,” or “configured to” in one or more embodiments, refers to some apparatus, logic, hardware, and/or element designed in such a way to enable use of the apparatus, logic, hardware, and/or element in a specified manner. The subject matter of the present disclosure is provided as examples of apparatus, systems, methods, and programs for performing the features described in the present disclosure. However, further features or variations are contemplated in addition to the features described above. It is contemplated that the implementation of the components and functions of the present disclosure can be done with any newly arising technology that may replace any of the above implemented technologies.

Additionally, the above description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, features described with respect to certain embodiments may be combined in other embodiments.

We claim:

1. An electronic device comprising:
a memory having stored therein: software, a configuration file, and a table associating reference Wi-Fi country codes with graphical user interface (GUI) languages; and
a processor configured to run the software to cause the electronic device to execute at least the following:
read a current Wi-Fi country code of the electronic device from the configuration file;
obtain, from the table, the GUI language which is associated with the reference Wi-Fi country code corresponding to the current Wi-Fi country code of the electronic device; and
modify the configuration file stored in the memory so as to automatically select a language setting for a GUI of the electronic device based on the GUI language obtained from the table.

2. The electronic device of claim 1, wherein the processor is configured to run the software to cause the electronic device to read the current Wi-Fi country code of the electronic device from the configuration file upon login to the GUI of the electronic device on a client device.

3. The electronic device of claim 1, wherein the processor is configured to run the software to cause the electronic device to automatically select the language setting for the GUI of the electronic device to match the GUI language obtained from the table if the reference Wi-Fi country code corresponding to the current Wi-Fi country code is associated with only one GUI language.

4. The electronic device of claim 1, wherein the processor is configured to run the software to cause the electronic device to automatically select the language setting for the GUI of the electronic device to be English if the reference Wi-Fi country code corresponding to the current Wi-Fi country code is associated with more than one GUI language.

5. The electronic device of claim 1, wherein the processor is configured to run the software to cause the electronic device to automatically select the language setting for the GUI of the electronic device to be English if the GUI language obtained from the table is unsupported.

6. A method implemented on an electronic device, the method comprising:
reading a current Wi-Fi country code of the electronic device from a configuration file stored in a memory of the electronic device;
obtaining, from a table stored in the memory associating reference Wi-Fi country codes with graphical user interface (GUI) languages, the GUI language which is associated with the reference Wi-Fi country code corresponding to the current Wi-Fi country code of the electronic device; and
modifying the configuration file stored in the memory so as to automatically select a language setting for a GUI of the electronic device based on the GUI language obtained from the table.

7. The method of claim 6, wherein the current Wi-Fi country code of the electronic device is read from the configuration file upon login to the GUI of the electronic device on a client device.

8. The method of claim 6, wherein the language setting for the GUI of the electronic device is automatically selected to match the GUI language obtained from the table if the reference Wi-Fi country code corresponding to the current Wi-Fi country code is associated with only one GUI language.

9. The method of claim 6, wherein the language setting for the GUI of the electronic device is automatically selected to be English if the reference Wi-Fi country code corresponding to the current Wi-Fi country code is associated with more than one GUI language.

10. The method of claim 6, wherein the language setting for the GUI of the electronic device is automatically selected to be English if the GUI language obtained from the table is unsupported.

11. A non-transitory computer readable recording medium having stored thereon a program implemented on an electronic device, the program causing the electronic device to perform steps comprising:
reading a current Wi-Fi country code of the electronic device from a configuration file stored in a memory of the electronic device;
obtaining, from a table stored in the memory associating reference Wi-Fi country codes with graphical user interface (GUI) languages, the GUI language which is associated with the reference Wi-Fi country code corresponding to the current Wi-Fi country code of the electronic device; and
modifying the configuration file stored in the memory so as to automatically select a language setting for a GUI of the electronic device based on the GUI language obtained from the table.

12. The non-transitory computer readable recording medium of claim 11, wherein the current Wi-Fi country code of the electronic device is read from the configuration file upon login to the GUI of the electronic device on a client device.

13. The non-transitory computer readable recording medium of claim 11, wherein the language setting for the GUI of the electronic device is automatically selected to match the GUI language obtained from the table if the reference Wi-Fi country code corresponding to the current Wi-Fi country code is associated with only one GUI language.

14. The non-transitory computer readable recording medium of claim 11, wherein the language setting for the GUI of the electronic device is automatically selected to be English if the reference Wi-Fi country code corresponding to the current Wi-Fi country code is associated with more than one GUI language.

15. The non-transitory computer readable recording medium of claim 11, wherein the language setting for the GUI of the electronic device is automatically selected to be English if the GUI language obtained from the table is unsupported.
